(19) United States
(12) Patent Application Publication
(10) Pub. No.: US 2005/0280236 A1
(43) Pub. Date: Dec. 22, 2005

(54) Independent front steering system for vehicles

(76) Inventor: Tony Vallejos, Spokane, WA (US)

Correspondence Address: WELLS ST. JOHN P.S., 601 W. FIRST AVENUE, SUITE 1300, SPOKANE, WA, 99201, US

(21) Appl. No.: 10/870,869

(22) Filed: Jun. 16, 2004

(51) Int. Cl. B60G 1/00

(52) U.S. Cl. 280/124.11

(57) ABSTRACT

A steering system, including an apparatus and a method, for a vehicle including a framework configured for operable attachment to a vehicle, a pivot rail attached to the framework, the pivot rail including a generally arcuate guide surface, a carriage pivotally connected to the framework such that the carriage pivots about a generally vertical axis, the carriage including at least one guide configured to engage the guide surface of the pivot rail, a wheel linkage movable mounted to the carriage such that the wheel linkage may move upward and downward; and a wheel coupler rotatably mounted relative to the carriage and which pivots with the carriage relative to the framework, the wheel coupler configured to operatively attach to a vehicle wheel. Embodiments of the invention may reduce the unsprung weight of the wheel.

### CROSS REFERENCE TO RELATED APPLICATION

There are no related applications.

### TECHNICAL FIELD

This invention generally pertains to an independent steering system for vehicles, and more particularly such a steering system which is preferably used on heavier vehicles with independent front suspension, although not limited to such a combination.

### BACKGROUND OF THE INVENTION

For many years a predominant type of steering system for vehicles has utilized a system in which the brakes and other components are suspended along with the wheel coupler, creating an undesirably high magnitude of the unsprung weight. Predominate systems may also utilize a center of rotation about a vertical axis which was inboard from the vertical center of the wheel. While these types of systems have been well developed in the industry, there are many benefits which can be achieved by reducing the unsprung weight and by moving the center of rotation of the wheel to the approximate center of the wheel.

It is also desirable to provide a steering system which does not require complete disassembly for repair, but instead the entire system can be attached and detached more quickly as a whole or in a modular fashion.

It is therefore an object of this invention to provide an improved steering system for vehicles, preferably such a system which provides independent suspension.

It is a further object of this invention to provide an improved steering system for vehicles.

### BRIEF DESCRIPTION OF THE DRAWINGS

Preferred embodiments of the invention are described below with reference to the following accompanying drawings:

FIG. 1 is a prospective view of one embodiment of a steering wheel system for vehicles as contemplated by this invention;

FIG. 2 is a front elevation view of the embodiment of the steering wheel system illustrated in FIG. 1, only with the wheel and tire removed for viewing other component parts;

FIG. 3 is a rear elevation view of the embodiment of the steering wheel system illustrated in FIG. 1;

FIG. 4 is a first side view of the embodiment of the steering wheel system illustrated in FIG. 1;

FIG. 5 is a top perspective view of the steering wheel system illustrated in FIG. 2, with the wheel and tire removed for better viewing;

FIG. 6 is a front perspective view of the steering wheel system illustrated in FIG. 1, with the tire, wheel and wheel coupling mechanism and axis removed for viewing of the other components;

FIG. 7 is a front perspective view of the embodiment of the steering wheel system illustrated in FIG. 6, only with the wheel coupler add thereto;

FIG. 8 is a front perspective view of the universal joint, axis, brake and A-frame from the embodiment of the invention illustrated in FIG. 1;

FIG. 9 is a front perspective view of the carriage utilized in the embodiment of the invention illustrated in FIG. 1;

FIG. 10 is a front perspective view of the brake and brake caliper utilized in the embodiment of the invention illustrated in FIG. 1;

FIG. 11 is a front perspective view of the framework utilized in the embodiment of the invention illustrated in FIG. 1;

FIG. 12 is a rear perspective view of the pivot rail utilized by the embodiment of the invention illustrated in FIG. 1;

FIG. 13 is a front perspective view of an A-arm utilized in the embodiment of the invention illustrated in FIG. 1;

FIG. 14 is a front perspective view of the axis coupler utilized by the embodiment of the invention illustrated in FIG. 1;

FIG. 15 is a front perspective view of an exemplary vehicle, showing the ease with which a modular embodiment of the invention may be installed;

FIG. 16 is a top schematic view illustrating general movements and rotation of the carriage about an axis; and

FIG. 17 is a top schematic view illustrating general movements and rotation of the carriage about an axis relative to the view shown in FIG. 16.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

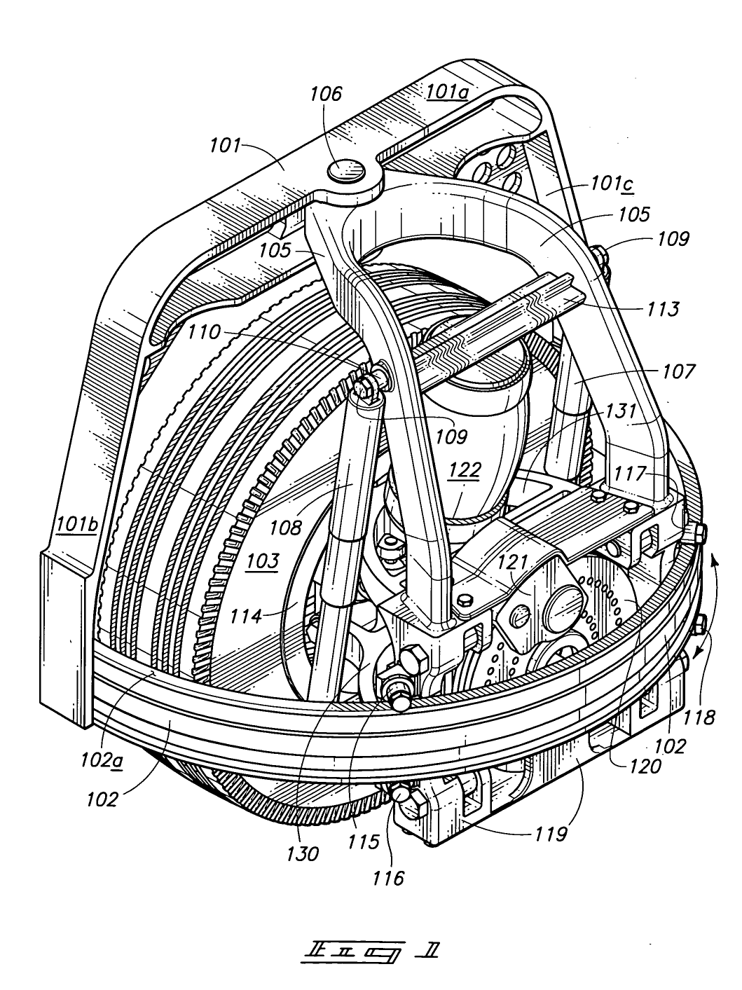

FIG. 1 is a prospective view of one embodiment of a steering system contemplated by this invention, illustrating framework 101 with top side 101a, first side 101b and second side 101c. FIG. 1 shows vehicle tire 103 mounted on vehicle wheel 114, carriage 105 pivotally attached to framework 101 via axis 106. Carriage 105 includes first rail guides 115 and 116 and second rail guides 117 and 118, which are configured to interact with pivot rail 102 with top 102a. In the embodiment of the invention shown in FIG. 1, the pivot rail 102 is arcuate and forms a half circle when viewed from a top view. The pivot rail provides a guide to assure the pivoting of 105 is supported and controlled as desired. It should be noted that while first and second rail guides 115 and 116 are shown, that one or more may be utilized within the contemplation of this invention, with no particular number or physical configuration being required to practice the invention.

It will be noted that the pivot rail further serves to support components that may otherwise be supported as unsprung weight, thereby potentially reducing or actually reducing the actual unsprung weight at the wheel. For instance, brake 120 and brake caliper 122 are carried on carriage 105, which pivots on pivot rail 102. The weight of the brake 120 and brake caliper 121 are supported by the interaction of the pivot rail guides (such as 115 or 117) on the pivot rail. Carriage framework 119 provides the framework for mounting and positioning of the components including the brake 120. Any type of brake may be used with this invention, disc brakes, drum brakes, or others, with no one in particular being required to practice aspects of the invention.

It will be appreciated by those of ordinary skill in the art that the pivot rails provide a guide surface which is generally arcuate, and preferably circular, although not required to be circular. In embodiments of the invention wherein f the pivot rail is not circular, an intermediate mechanism may be required to continue to allow the carriage to rotate about its axis and be guided and/or supported by the pivot rail. The guide surface may also be a flat plate which provides a support surface on which the guide(s) may move in an arcuate or other motion.

The suspension of the wheel is accomplished via shock absorbers 107 and 108, combined with bellows or air shock 122, all of which are mounted between carriage 105 and the suspended portion of the wheel configuration, which is better shown in later figures. Beam 113 between portions of carriage 105 provides a support attachment 110 with bolts 109, whereby shock absorbers 108 and 107 are attached to the carriage and rotate therewith. As will be better shown in later figures, rods 130 and 131 provide structure for mounting the suspension relative to the unsprung portion of the wheel configuration.

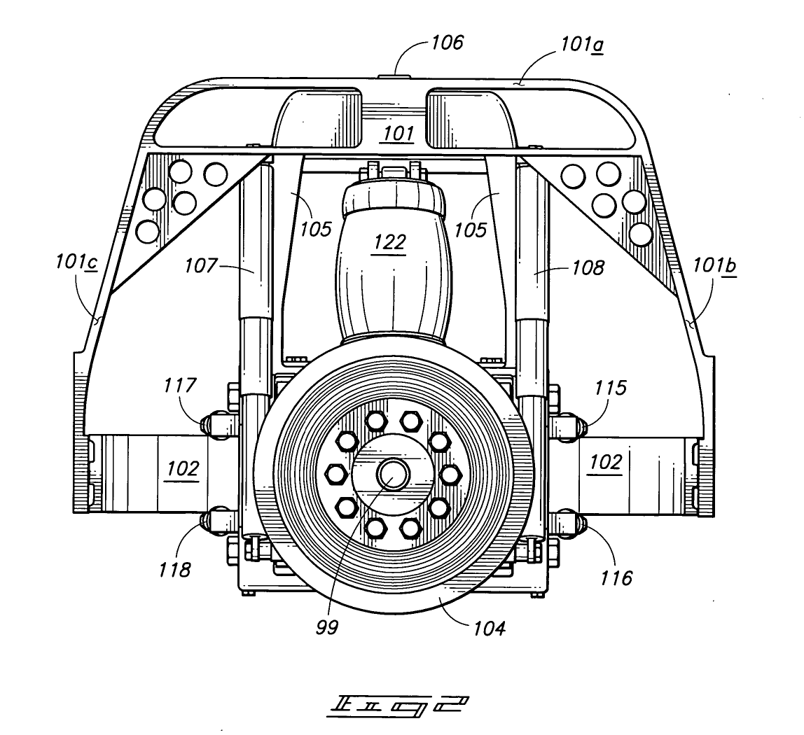

FIG. 2 is a front elevation view of the embodiment of the invention shown in FIG. 1, only without the tire and wheel. FIG. 2 illustrates framework 101 with top side 101a, first side 101b and second side 101c, wheel axis 99, hub 104, air shock 122, shock absorbers 107 and 108, pivot rail 102, rail guides 115, 116, 117 and 118, and pivot axis 106 about which carriage 105 rotates and which is configured to be centered above the center line of a wheel mounted to hub 104.

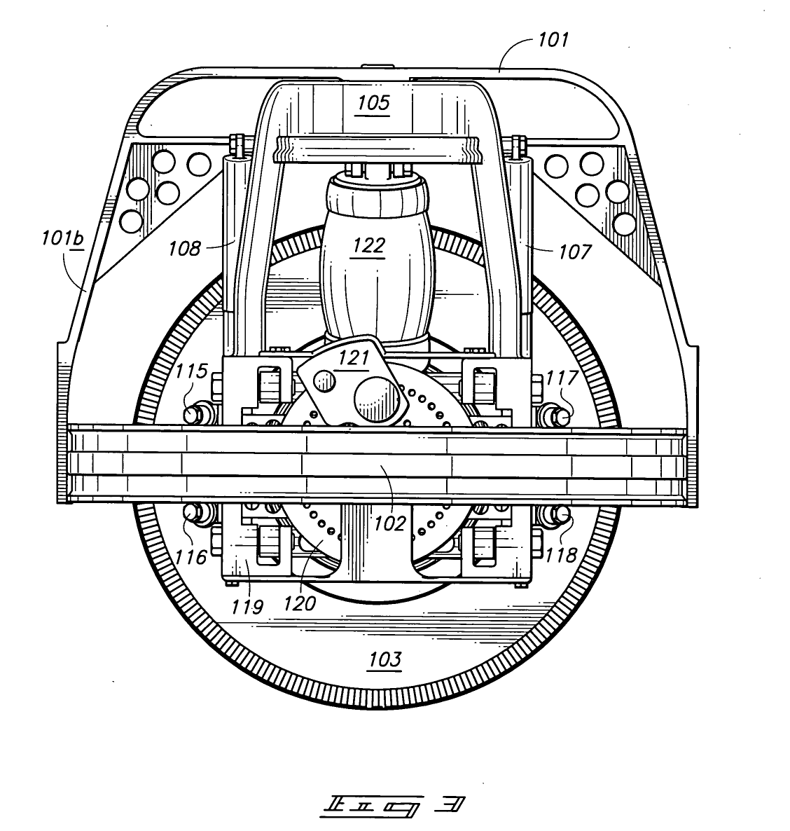

FIG. 3 is a rear elevation view of the embodiment of the invention shown in FIG. 1, illustrating framework 101 with first side 101b, carriage 105, shock absorbers 107 and 108, air shock 122, brake 120, brake caliper 121, pivot rail 102, tire 103, rail guides 115, 116, 117 and 118, and carriage framework 119.

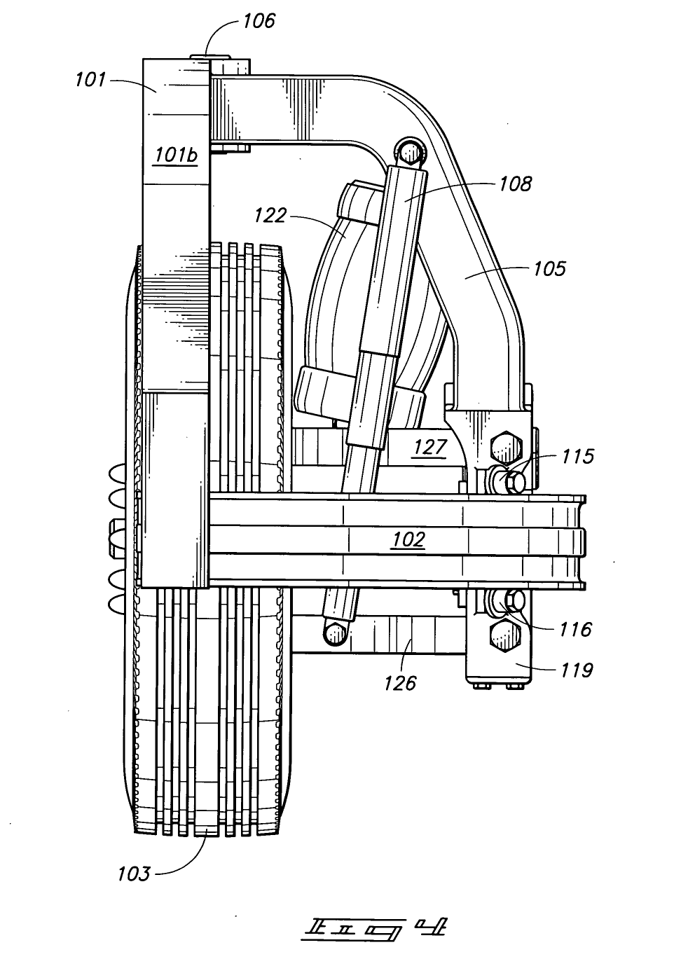

FIG. 4 is a second side elevation view of the embodiment of the invention shown in FIG. 1, illustrating framework 101, tire 103, carriage pivot axis 106, carriage 105, second shock absorber 108, air shock 122, rail guides 115 and 116, and carriage framework 119, upper A-arm 127 and lower A-arm 126.

FIG. 5 is a top—side perspective view of the embodiment of the invention shown in FIG. 1, with suspension and other components removed to better illustrate the drive train components. FIG. 5 illustrates top side 101a of framework 101, carriage 105, suspension carriage pivot axis 106, hub 104 with lug bolts 162, wheel hub carrier 163 with first A-arm mount 164 and second A-arm mount 166, with first mount bolt 165 and second A-arm mount 167. The A-arm mounts 165 and 167 provide a mounting position for the upper A-arm and the lower A-arm to be mounted and onto which shock absorbers can be attached to provide shock absorption features.

FIG. 5 further illustrates drive link 160 with universal joint connection 160a and corresponding universal joint connection 161 for the wheel axis. The wheel axis rotates within wheel hub carrier 163 to provide rotation to the hub 104 and a wheel mounted on hub 104. All other components and items shown and/or numbered are as identified above with respect to other figures and will not therefore be repeated here.

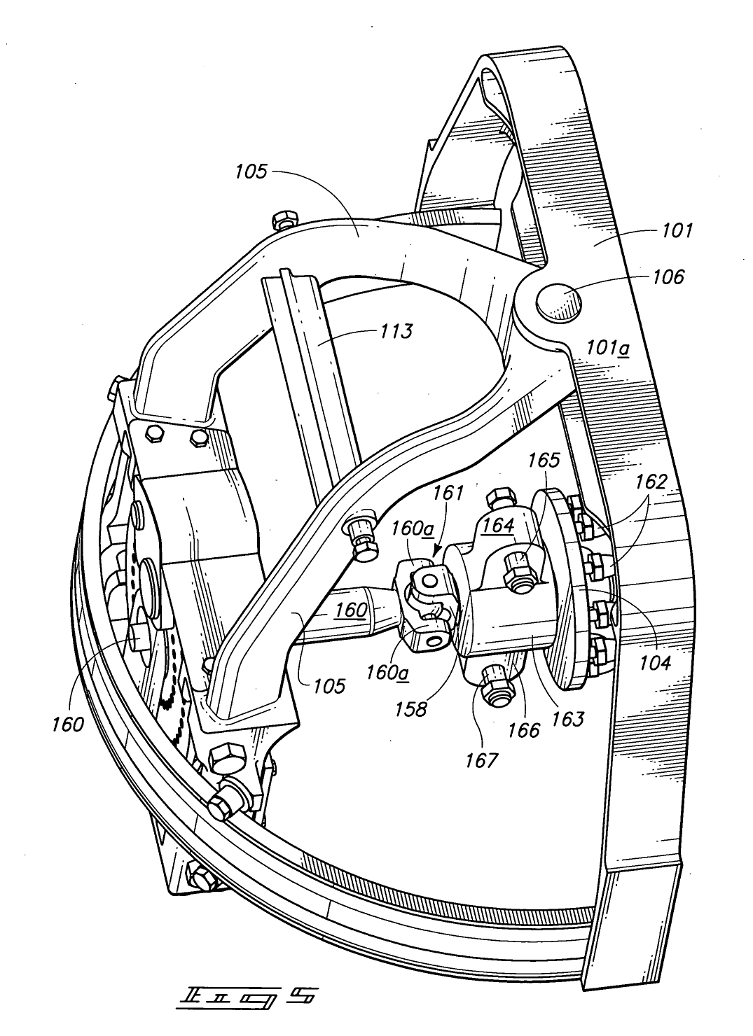

FIG. 6 is a rear prospective view of the embodiment of the invention illustrated in FIG. 1, with the wheel coupler, wheel and tire removed for better viewing of other components. FIG. 6 illustrates framework 101, carriage 105, carriage pivot axis 106, lower A-arm 126 and upper A-arm 127 pivotally mounted to wheel hub carrier 163 via A-arm mounts 165 and 167. Shock absorbers 107 and 108 are mounted to carriage 105 mounted at a top end to carriage 105 and at a lower end to lower A-arm 126 to provide shock absorption features to the components operatively attached to the upper A-arm 127 and lower A-arm 126 on the wheel side of the A-arms and away from the pivot rail 102 side of the A-arms. Bellows, or air shock 122 is attached at a top end to carriage 105 and at a bottom end to upper A-arm 127 to further provide shock absorption and rebound features to the vehicle wheel. Shock mount bolts 172 are attached to lower A-arm 126 for mounting shock absorbers 107 and 108 to lower A-arm 126. It will be noted by those of ordinary skill in the art that while this system is shown with more than one shock absorber, it may also be utilized within the contemplation of this invention with one or more shock absorbers, with no particular number being required to practice this invention. It will also be appreciated that while specific air springs, hydraulic or other shock absorption mechanisms are shown, any one of a number of different types of shock absorption may be utilized within the contemplation of this invention.

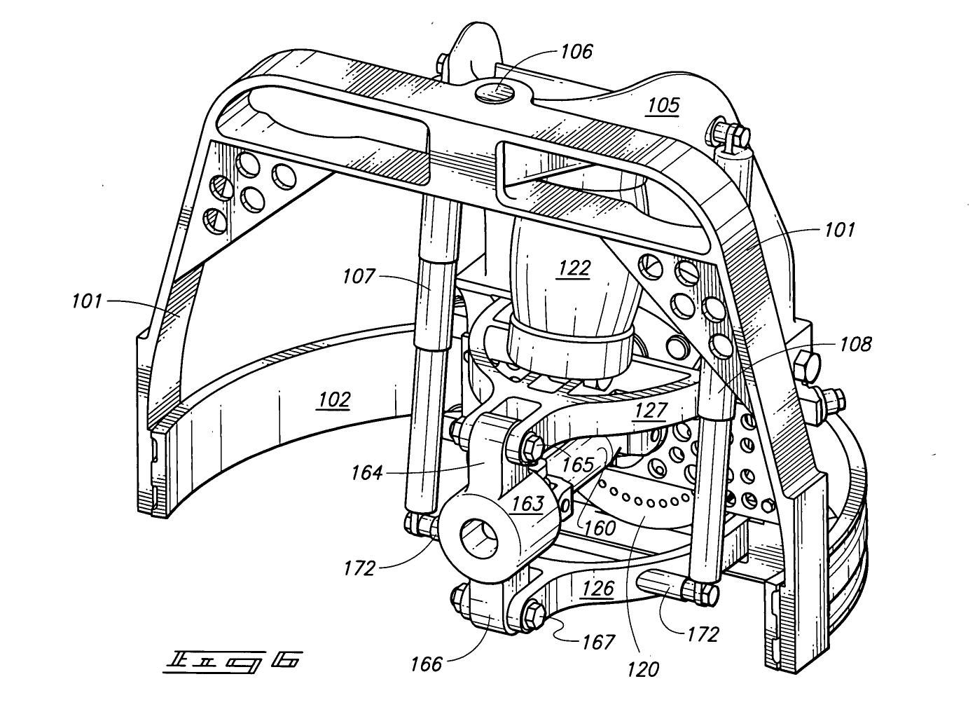

FIG. 7 is a front perspective view of the embodiment of the invention shown in FIG. 6, only with wheel coupler 171 with lug bolts 162 inserted therein. All other item numbers are the same as in FIG. 6, and will not therefore be repeated here.

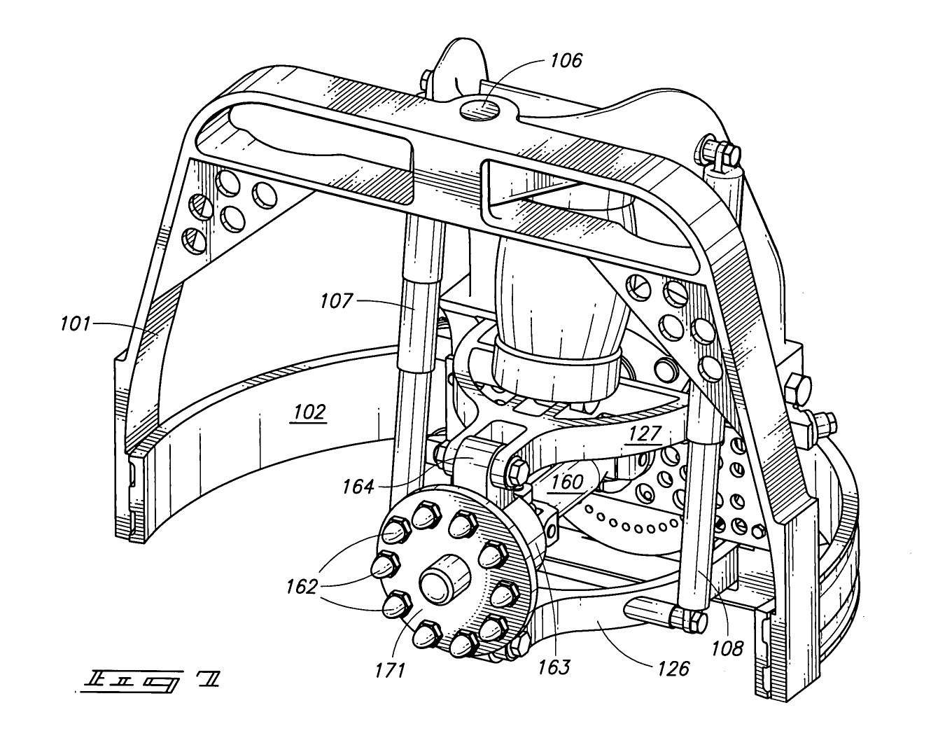

FIG. 8 is a front perspective view of lower A-arm 126 relative to the brake 120 and drive link 160. FIG. 8 illustrates brake 120, brake caliper 121, lower A-arm 126 with shock absorber mounts 172 attached to lower A-arm 126. A-arm mount 167 across the harness in lower A-arm 126 provides a pivotal mounting point for mounting wheel hub carrier 163 (as shown in other figures). A first side 160a of drive link 160 is configured to couple in a universal joint as shown, and at a second side 160b is configured to operatively connect, couple with or attach to a brake coupling 159.

FIG. 9 is a front perspective view of one embodiment of a carriage 105 which may be utilized in the embodiment of the invention illustrated in FIG. 1. FIG. 9 illustrates carriage 105, pivot axis aperture 180, beam 113 and guides 181 and 182 within the lower part of carriage 105 to provide the configuration to allow mounting of other components through the carriage, as those of ordinary skill in the art will appreciate.

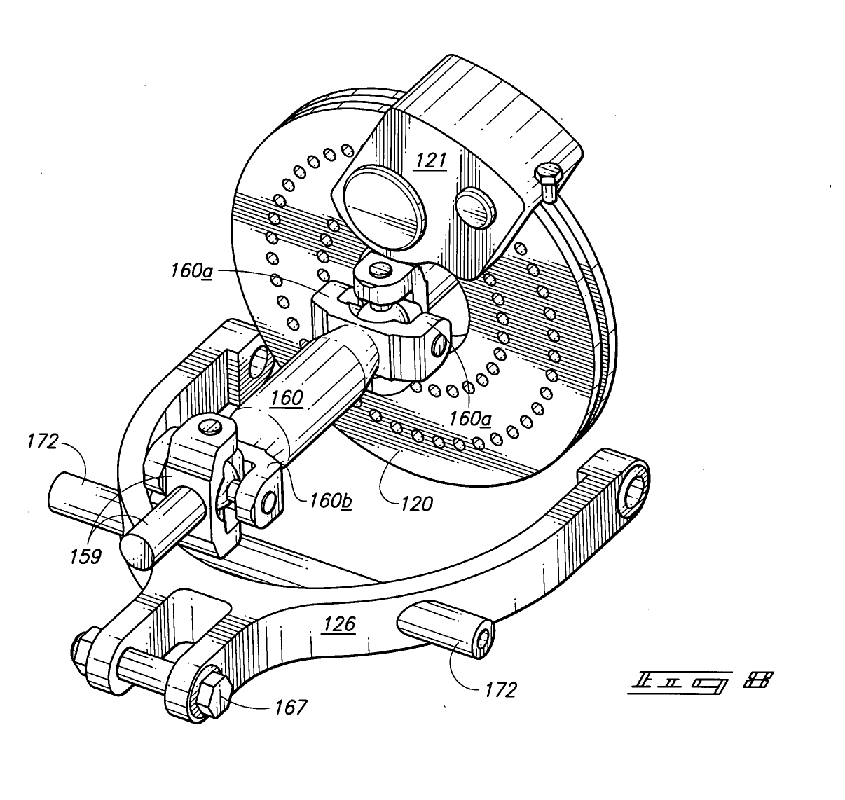

FIG. 10 is a rear perspective view of a brake and caliper configuration with dual brake pads 120 and caliper 121, which is an embodiment of a brake configuration which may be used in combination with other elements as part of this invention. It will be appreciated that any one of a number of brake configurations and types may be utilized with this invention, with no one in particular being required to practice the invention, as will be appreciated by those of ordinary skill in the art.

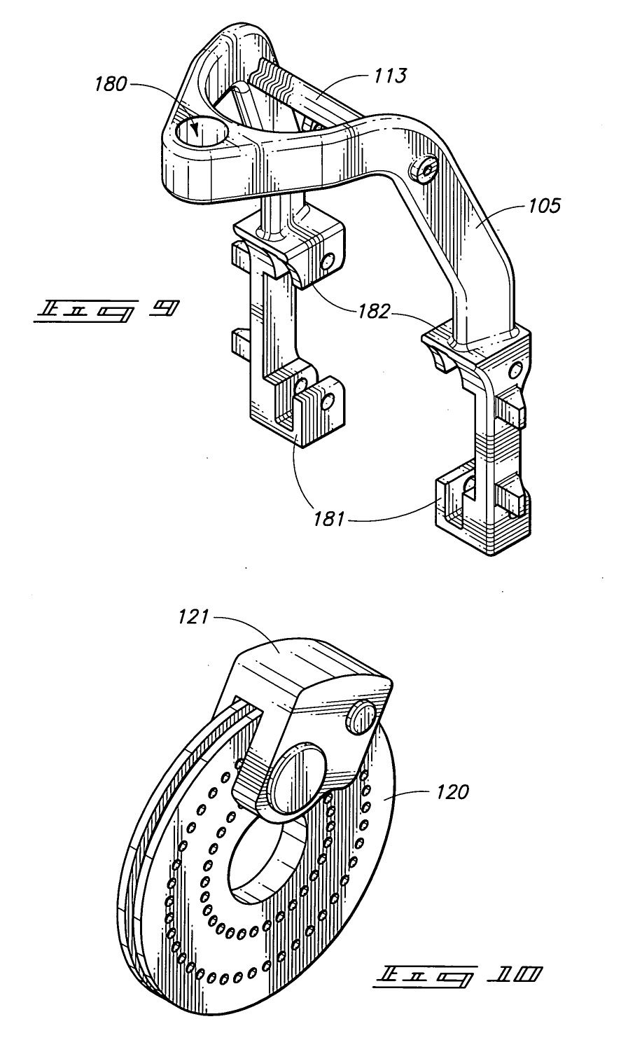

FIG. 11 is a rear perspective view of framework 101 with top side 101a, first side 101b and second side 101c. It would be appreciated by those of ordinary skill in the art that any one of a number of different types and configurations of frameworks may be utilized within the contemplation of this invention. However, as more fully discussed below, for some embodiments of this invention, it is preferred to have a modular steering wheel system such that the framework may be inserted into a cavity in a vehicle and the entire steering and suspension system can be replaced as a unit, in a quicker fashion and then the one in need of replacement or repair can be repaired away from the vehicle. The framework 101 may be configured to accomplish this aspect of the invention depending on the application in a vehicle.

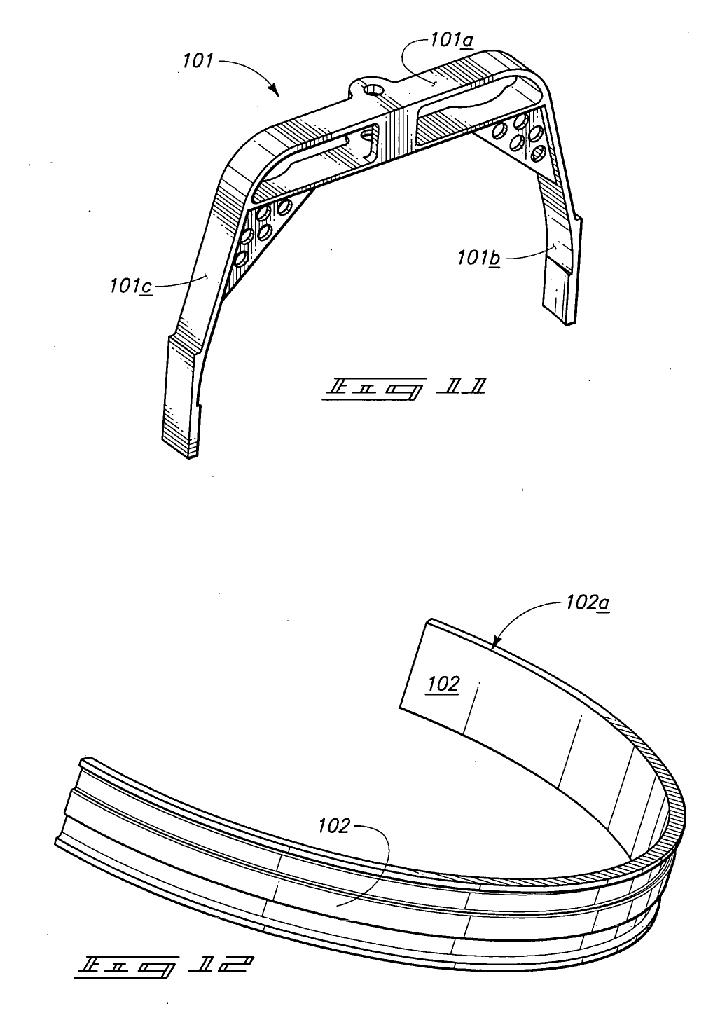

FIG. 12 is a rear perspective view of pivot rail 102 with top side 102a. The pivot rail provides the support structure on which the carriage is supported as the carriage pivots about its axis and provides steering. The pivot rail 102 is attached to framework 101 (shown in other figures) and provides support for weight of components the designer does not want to be unsprung weight. For instance, in this invention, the braking system, the carriage and other components are supported by pivot rail 102 instead of being unsprung weight on the wheel side of the wheel axle, therefore providing many desirable features on the vehicle.

FIG. 13 is a front perspective view of a lower A-arm 127, which may be utilized in an embodiment of this invention, showing wheel axle collar mounts 127a, where the A-arm may be pivotally mounted to a wheel axle collar. FIG. 13 further illustrates carriage mount arms 127b, at which the A-arm 127 may be pivotally mounted to a carriage such that the carriage end of A-arm 127 pivots relative to the carriage. In order to accomplish the pivoting in the A-arm relative to other components, bushings or other known bearing and other rotation devices may be utilized, all of which are generally well known in the art and will not be discussed in further detail herein.

FIG. 13 further shows air shock mounts 127c for operatively attaching and pivotally attaching a lower end of an air shock to A-arm 127.

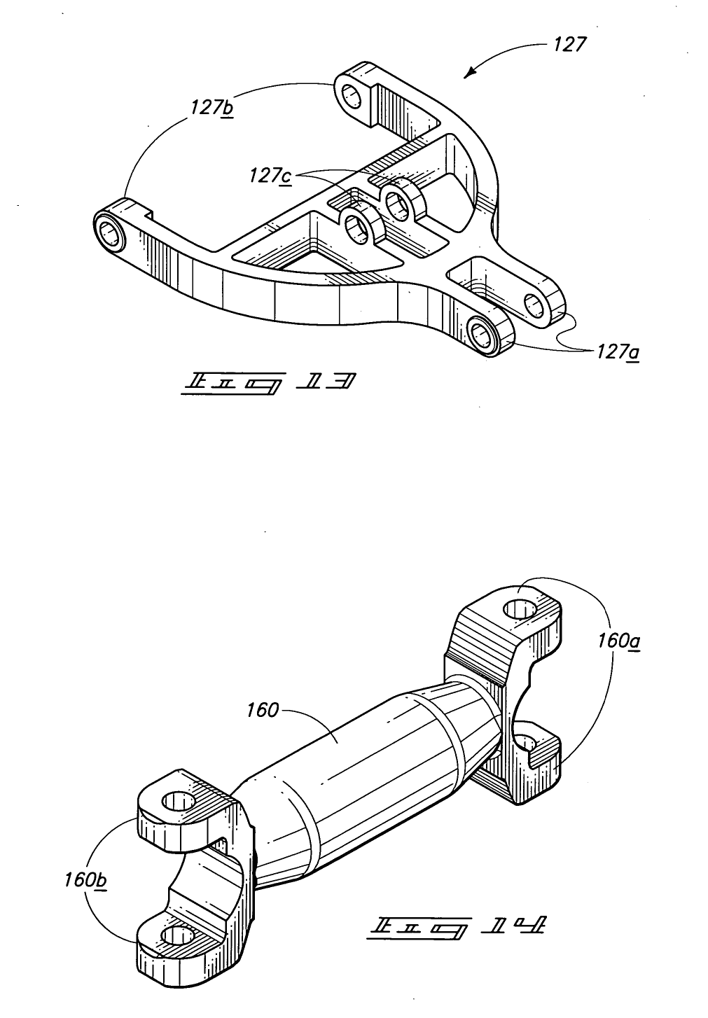

FIG. 14 is a front perspective view of a drive link 160 with first end 160a and second end 160b, the first end being configured to couple with wheel shaft coupling 158 (as shown in FIG. 5), in a universal type connection. The second end 160b is configured to couple to a brake coupling 159 (as shown more fully in FIG. 8 above). It will be appreciated by those of ordinary skill in the art that there are multiple ways to configure the drive components and couplings, with no one in particular necessarily being required to practice this invention.

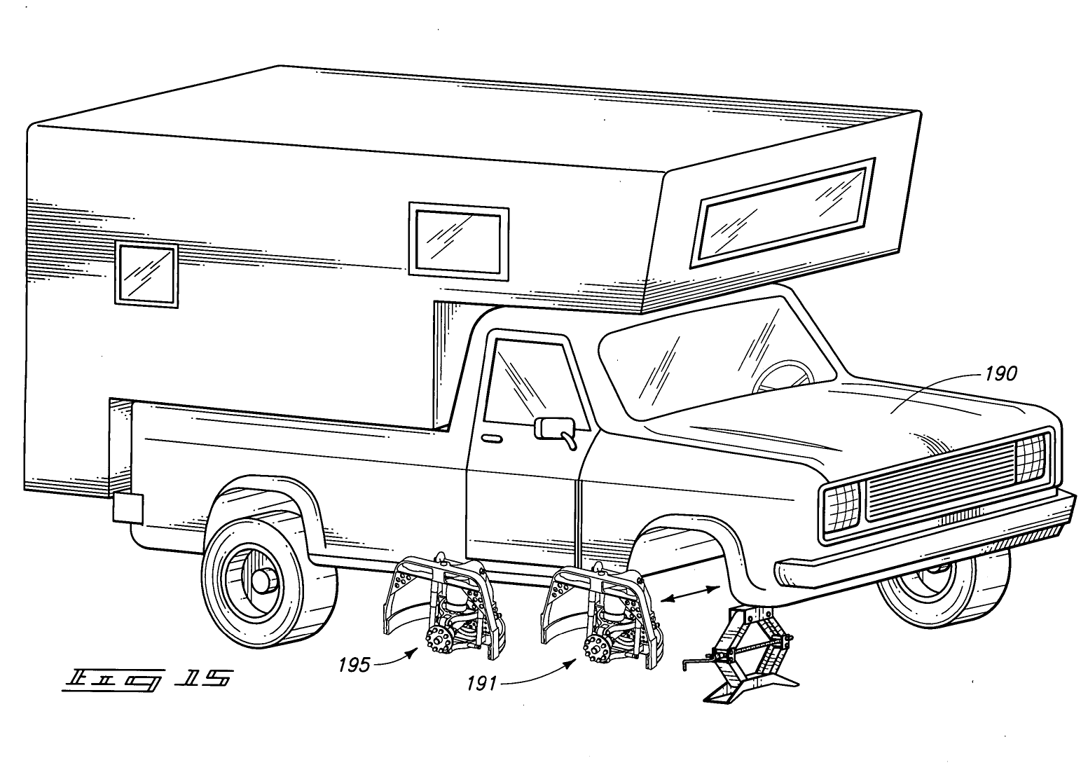

FIG. 15 is a perspective view of a vehicle 190 illustrating how the embodiment of the invention illustrated in FIG. 1 for instance can easily be installed as a unit or in a modular fashion, or conversely removed, from a vehicle. Placing the steering system, the suspension system and the braking system on a self contained framework allows such a framework to be operably attached to a vehicle (such as to the frame of the vehicle), and then easily removed for repair or maintenance. Embodiments of this invention thereby allow the system to be removed and replaced in a modular fashion to keep the vehicle on the road while the first steering system is being repaired.

FIG. 15 illustrates a first steering and suspension system 191 removed from the vehicle 190, and a second steering and suspension system 192 being attached to the vehicle 190.

The system may be attached and detached by attaching and detaching the system framework to the vehicle and by operatively connecting or attaching the wheel axle, coupler or drive linkage to that of the vehicle.

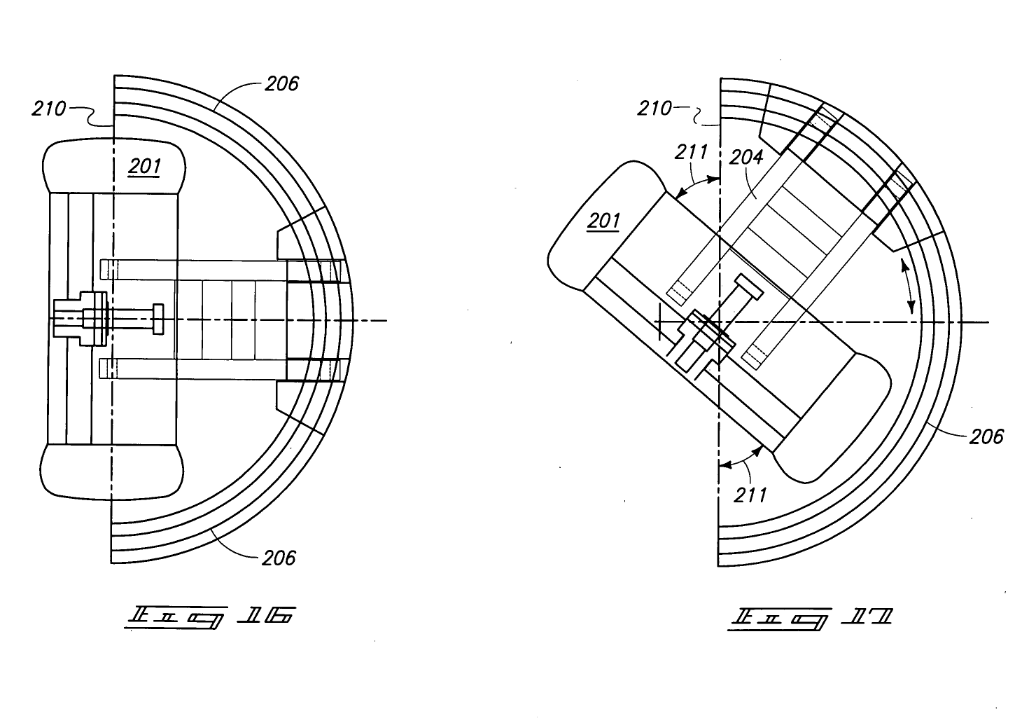

FIG. 16 is a top schematic view illustrating general movements and rotation of the carriage about an axis, showing guide rail 206, a partial circle, tire 201 and the centerline or an axis of tire and of the wheel. In FIG. 16 the wheel is shown in its straight ahead position.

FIG. 17 is a top schematic view illustrating general movements and rotation of the carriage about a vertical pivot axis relative to the view shown in FIG. 16, showing the tire 201 at angle 211 from the view shown in FIG. 16. FIG. 17 also identifies carriage 204, guide rail 206, and illustrates the rotation of the carriage 204 with the wheel from centerline 210.

The unsprung weight on a given wheel and steering configuration is generally the total weight of all components, namely the wheel, tire, axles, brakes and steering components that are not actually held up by the springing mechanism of the vehicle. H vehicle with a very high unsprung weight will be a rougher ride as there is more weight not otherwise supported, normally including increased vibration, reduced handling and may include limitations to the braking systems that may be employed due to weight considerations. It will be appreciated by those of ordinary skill in the art that embodiments of this invention may result in reduced or greatly reduced unsprung weight since some or all of the breaking components are sprung weight instead of unsprung weight.

The weight of the braking system shown in FIG. 1 for example is supported by a support surface on the pivot rail 102 as one example, which is indirectly operatively attached to the frame of the vehicle and not on moving up and down with the wheel of the vehicle or supported by the wheel of the vehicle.

As will be appreciated by those of reasonable skill in the art, there are numerous embodiments to this invention, and variations of elements and components which may be used, all within the scope of this invention.

### TO BE COMPLETED ONCE WE HAVE AGREED ON FINAL CLAIM LANGUAGE

One embodiment of this invention, for example, is a

In a further embodiment of the embodiment described in the preceding paragraph,

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A steering system for a vehicle, comprising:
a framework configured for operable attachment to a vehicle, the framework including a pivot rail with a generally arcuate guide surface;
a carriage pivotally attached to the framework such that the carriage pivots about a generally vertical axis, the carriage including at least one guide configured to engage the guide surface of the pivot rail;
a wheel linkage movably mounted to the carriage such that the wheel linkage may move upward and downward; and
a wheel coupler rotatably mounted relative to the carriage and which pivots with the carriage relative to the framework, the wheel coupler being configured to operatively attach to a vehicle wheel.

2. A steering wheel system for a vehicle as recited in claim 1, and further wherein the carriage is at least partially supported by the arcuate guide surface on the pivot rail.

3. A steering wheel system for a vehicle as recited in claim 1, and further wherein the framework is configured for direct attachment to the vehicle.

4. A steering wheel system for a vehicle as recited in claim 1, and further comprising a brake mounted to the carriage and operatively attached to the wheel coupler.

5. A steering wheel system for a vehicle as recited in claim 4, and further wherein the wheel braking system is mounted to the pivot rail.

6. A steering wheel system for a vehicle as recited in claim 1, and further wherein the arcuate guide surface is a partial circle.

7. A steering wheel system for a vehicle as recited in claim 1, and further wherein the wheel coupler is configured such that a wheel mounted to the wheel coupler pivots with the carriage and pivots about a vertical axis which is an approximate central pivot axis of the wheel.

8. A steering wheel system for a vehicle as recited in claim 1, and further wherein at least part of the framework is integral with the vehicle.

9. A steering wheel system for a vehicle as recited in claim 1, and further wherein the pivot rail is integral with the vehicle.

10. A steering wheel system for a vehicle as recited in claim 1, and further comprising a braking system operatively attached to the carriage.

11. A steering wheel system for a vehicle as recited in claim 1, and further wherein the wheel coupler is configured to operatively attach directly to the vehicle wheel.

12. A steering wheel system for a vehicle as recited in claim 1, and further comprising a wheel suspension system which comprises:
a shock absorber operatively connected at a first end to the carriage and operatively connected at a second end relative to the wheel coupler such that the shock absorber absorbs vertical movement between the wheel coupler and the carriage, thereby providing suspension.

13. A steering wheel system for a vehicle as recited in claim 12, and further wherein the shock absorber is a first shock absorber, and further comprising a second shock absorber operatively connected at a first end to the carriage and operatively connected at a second end relative to the wheel coupler such that the second shock absorber absorbs vertical movement between the wheel coupler and the carriage, thereby providing suspension.

14. An interchangeable modular steering and suspension system for a vehicle, comprising:
a first steering and suspension system and second steering and suspension system, each comprising:
a framework configured for attachment to a vehicle;
a carriage pivotally mounted to the framework such that the carriage pivots about a generally vertical axis;
a wheel linkage movable mounted to the carriage such that the wheel linkage may move upward and downward, and configured for attachment to a wheel axis; and
a wheel coupler rotatably mounted relative to the carriage and which pivots with the carriage relative to the framework, the wheel coupler configured to operatively attach to a vehicle wheel;
and wherein the first steering and suspension system is interchangeable with the second steering and suspension system such that the framework of the first steering and suspension system may be detached from a vehicle and the framework of the second steering and suspension system may be attached to the vehicle.

15. A process for interchanging a second steering and suspension system for a first steering and suspension system mounted on a vehicle, comprising the following:
providing a first steering and suspension system and second steering and suspension system, the first being mounted within a wheel well on a vehicle, and each of the first and second steering and suspension systems comprising:
a framework configured for attachment to a vehicle;
a carriage pivotally mounted to the framework such that the carriage pivots about a generally vertical axis;
a wheel linkage movable mounted to the carriage such that the wheel linkage may move upward and downward, and configured for attachment to a wheel axis; and
a wheel coupler rotatably mounted relative to the carriage and which pivots with the carriage relative to the framework, the wheel coupler configured to operatively attach to a vehicle wheel;
detaching the framework and the wheel linkage of the first steering and suspension system from the vehicle, thereby removing the first steering and suspension system from the vehicle; and
attaching the framework and the wheel linkage of the second steering and suspension system to the vehicle.

16. A steering system for a vehicle, comprising:
a framework configured for attachment to a vehicle;
a pivot rail attached to the framework, the pivot rail including a generally arcuate guide surface;
a carriage pivotally connected to the framework such that the carriage pivots about a generally vertical axis, the carriage including at least one guide configured to engage the guide surface of the pivot rail;
a wheel linkage movable mounted to the carriage such that the wheel linkage may move upward and downward;
a wheel coupler rotatably mounted relative to the carriage and which pivots with the carriage relative to the framework, the wheel coupler configured to operatively attach to a vehicle wheel.
a wheel suspension system comprised of:
at least one shock absorber operatively connected at a first end to the carriage and operatively connected at a second end relative to the wheel such that the at least one shock absorber absorbs vertical movement from the wheel coupler to provide suspension; and
a wheel braking system comprised of:
a brake operatively attached to a wheel linkage and configured to brake rotation of a vehicle wheel and supported by the pivot rail.

17. A steering system for a vehicle, comprising:
a framework configured for attachment to a vehicle;
a carriage means pivotally connected to the framework to pivot about a generally vertical axis, the carriage including at least one guide configured to engage a guide means attached to the framework;
a wheel linkage means movable mounted to the carriage such that the wheel linkage means may move upward and downward; and
a wheel coupling means rotatably mounted relative to the carriage means and which pivots with the carriage relative to the framework, the wheel coupling means configured to operatively attach to a vehicle wheel.

18. A steering system for a vehicle, comprising:
a framework configured for operable attachment to a vehicle;
a braking system configured for the application of braking to a wheel, said braking system being supported by the framework;
such that the braking system is part of the sprung weight of the vehicle.

19. A steering system for a vehicle, comprising:
a framework configured for operable attachment to a vehicle;
a pivot rail attached to the framework, the pivot rail including a generally arcuate guide surface;
a carriage pivotally connected to the framework such that the carriage pivots about a generally vertical axis, the carriage including at least one guide configured to engage the guide surface of the pivot rail;
a braking system configured for the application of braking to a wheel, said braking system being operably attached to the carriage and the weight of the braking system is substantially supported by the pivot rail; and
wherein the braking system is part of the sprung weight of the vehicle.
